(19) United States
(12) Patent Application Publication
(10) Pub. No.: US 2014/0352841 A1
(43) Pub. Date: Dec. 4, 2014

(54) INSULATING GLASS UNIT FILLED WITH ADSORBABLE GAS

(71) Applicant: Cardinal IG Company, Eden Prairie, MN (US)

(72) Inventor: Benjamin J. Zurn, Roseville, MN (US)

(73) Assignee: Cardinal IG Company, Eden Prairie, MN (US)

(21) Appl. No.: 14/278,817

(22) Filed: May 15, 2014

Related U.S. Application Data
(60) Provisional application No. 61/829,085, filed on May 30, 2013.

(51) Int. Cl. E06B 3/677

(52) U.S. Cl. CPC E06B 3/6775
USPC 141/8

(57) ABSTRACT

An insulating glass unit may be fabricated by filling the space between opposed panes of glass with multiple types of gases and then sealing the gases in the space. A spacer containing a gas adsorption material may be positioned between the panes of glass to seal the gases in the space. In some examples, the gas adsorption material is configured to selectively adsorb one of the gases introduced into the space but substantially none of another of the gases introduced into the space. As a result, the gas pressure in the insulating glass unit may reduce below the initial filling pressure after fabrication of the unit due to adsorption. Such gas pressure reduction may be useful, for example, if the insulating glass unit is going to be used at a higher elevation location where the air pressure is lower.

### RELATED APPLICATIONS

This application claims priority to U.S. Provisional Application No. 61/829,085 filed May 30, 2013, the teachings of which are incorporated herein by reference.

### TECHNICAL FIELD

This disclosure relates to insulating glass units and, more particularly, to insulating glass units filled with an adsorbable gas.

### BACKGROUND

Insulating glass units are generally formed from two or more parallel panes of glass which are spaced apart from each other and which have the space between the panes sealed along the peripheries of the panes to enclose a gas space between them. For example, a double pane window may be formed from two panes of glass, often rectangular in shape, which are placed in congruent relationship. A spacer is typically positioned around and between the peripheral edges of the two panes of glass so as to seal a gas space between the two panes of glass. Depending on the construction of the insulating gas unit, the gas space may or may not be filled with insulating gas such as dry air, argon, krypton, or the like.

Because insulating gas units have a sealed gas space, the structure of the insulating glass unit may be impacted by changes in the ambient pressure surrounding the insulating glass unit. For example, when an insulating glass unit is filled with an insulating gas at a location of manufacture, the gas sealed inside the insulating glass unit is often at the same pressure as the surrounding atmosphere. If, however, the insulating glass unit is subsequently shipped from the point of manufacture to a point of use that is at a substantially different elevation, the pressure inside the insulating glass unit may vary meaningfully from the ambient pressure at the point of use. For instance, if an insulating glass unit is manufactured around sea level to contain an ambient pressure sealed gas and then transported to a high elevation point of use, the ambient pressure at the point of use may be meaningfully lower than the pressure of the gas sealed inside the insulating glass unit. When this occurs, the glass panes of the insulating glass unit may bow outward, resulting in convex shaped glass panes. This can cause optical distortion when viewing through the insulating glass unit and an undesired physical appearance for the unit. Further, pressure differences can create tensile stress on the peripheral seal of the insulating glass unit, potentially weakening the seal and leading to seal failure.

### SUMMARY

In general, this disclosure is directed to insulating glass units and techniques for manufacturing insulating glass units. In some examples, a manufacturing technique involves filling a between-pane space located between a first glass pane and a second glass pane of an insulating glass unit with multiple different types of gases. The between-pane space may be sealed with a spacer to trap the multiple different types of gases in the between-pane space bounded by the glass panes and the spacer. The spacer may contain a gas adsorption material, such as desiccant, that is configured to adsorb any water vapor that may be present in the between-pane space and at least one, but not all, of the multiple different types of gases in the space. For example, if the insulating glass unit were to be filled with carbon dioxide and argon, the gas adsorption material may be configured to adsorb substantially all of the carbon dioxide in the insulating glass unit but substantially none of the argon.

During assembly, the between-pane space of the insulating glass unit can be filled with the multiple different types of gases to a certain pressure, such ambient pressure at the location where the insulating glass unit is being manufactured. After being manufactured, any water vapor that may be present in the insulating glass unit and/or at least one of the types of gases with which the insulating glass unit was filled may be adsorbed by the gas adsorption material. When this occurs, the gas pressure in the insulating glass unit can reduce below the initial gas pressure in the unit at the time of manufacture. For example, if the insulating gas unit is filled with ambient pressure gas at the location of manufacture, gas adsorption by the gas adsorption material can cause the pressure in the insulating unit to fall below ambient pressure, creating a partial vacuum inside the unit.

An insulating glass unit containing reduced pressure insulating gas may be useful in instances in which the insulating glass unit is manufactured at one location and then transported to a location of intended use that is at a higher elevation than the location of manufacture. For example, an insulating glass unit that is at a partial vacuum relative to ambient pressure at the location of manufacture may, upon being transported to the high elevation location of intended use, be at a pressure substantially equal to the ambient pressure at the location of intended use. This is because ambient pressure at the high elevation location of use will typically be at a lower absolute pressure than the ambient pressure at the comparatively low elevation location of manufacture. By manufacturing the insulating glass unit with an adsorbable gas and a gas adsorption material, the insulating glass unit may be used in a high elevation location without requiring a valve or other mechanism that punctures the insulating glass unit seal so as to adjust the gas pressure inside the unit. Of course, the insulating glass unit may also be used in other applications beyond installing the unit at a higher elevation location than the location of manufacture.

In one example, a method is described that includes filling a between-pane space defined between a first pane of transparent material and a second pane of transparent material with a plurality of gases. The plurality of gases includes a first gas composition and a second gas composition. The example also includes positioning a spacer between the first pane of transparent material and a second pane of transparent material so as to seal the between-pane space from gas exchange with a surrounding environment. The spacer includes a gas adsorption material configured to adsorb the first gas composition. The example method further involves reducing a gas pressure in the between-pane space via adsorption of the first gas composition by the gas adsorption material so that the gas pressure in the between-pane space is reduced below atmospheric pressure.

In another example, a method is described that includes filling a between-pane space defined between a first glass pane and a second glass pane with a plurality of gases, where the plurality of gases include a first gas defining a first molecular size and a second gas defining a second molecular size larger than the first molecular size. The example includes sealing the between-pane space from gas exchange with a surrounding environment with a spacer so as to form an insulating glass unit. The spacer includes a gas adsorption material that has pores sized to allow passage of the first gas into the gas adsorption material and to substantially exclude passage of the second gas into the gas adsorption material. The example further includes removing a portion of the first gas from the between-pane space via adsorption of the first gas by the gas adsorption material so as to reduce a pressure in the between-pane space.

In another example, a method is described that includes positioning a first pane of transparent material so that the first pane of transparent material is generally parallel to and spaced apart from a second pane of transparent material, and filling a between-pane space defined between a first pane of transparent material and a second pane of transparent material with a plurality of gases. The method also involves positioning a spacer between the first pane of transparent material and a second pane of transparent material so as to seal the between-pane space from gas exchange with a surrounding environment and so as to form an insulating glazing unit. In addition, method includes adsorbing one of the plurality of gases from the between-pane space via a desiccant positioned within the between-pane space while another of the plurality of gases is substantially unadsorbed by the desiccant so as to reduce a pressure in the between-pane space.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a perspective drawing of an example insulating glass unit.

FIG. 2 is a cross-sectional view of an example configuration of the insulating glass unit in FIG. 1.

FIG. 3 is a cross-sectional view of another example configuration of the insulating glass unit in FIG. 1.

FIG. 4 is a flow chart illustrating an example method of fabricating an insulating glass unit.

### DETAILED DESCRIPTION

In general, an insulating glass unit provides an optically transparent thermally insulating structure that can be mounted in the wall of a building. In different examples, the insulating glass unit may be fabricated from two panes of material, which may be referred to as a double pane insulating glass unit, three panes of material, which may be referred to as a triple pane insulating glass unit, or even four or more panes of material. Each pane of material in the insulating glass unit may be separated from an opposing pane of material by a between-pane space, which may be filled with an insulating gas.

During manufacture of the insulating glass unit, the insulating gas may be dispensed into the between-pane space and then sealed in the space by inserting a spacer between opposed panes of transparent material. The spacer may hold the panes of transparent material in a generally parallel and spaced-apart orientation. The spacer may also seal the between-pane space so that the gas dispensed into the space is isolated from any gas in the ambient environment surrounding the insulating gas unit.

In some applications, the insulating glass unit is fabricated at one manufacturing location and then transported to a different physical location where the insulating glass unit is sold and/or installed in a building. During this process, the insulating glass unit may be transported from a location having a certain ambient pressure to a different location having a different ambient pressure. For example, the insulating glass unit may be manufactured at a location that is at one elevation with respect to sea level and then transported to a different location that is at a higher elevation with respect to sea level. The higher elevation location will typically have a lower ambient pressure than the location at the lower elevation. If the pressure of the gas in the insulating glass unit is too high in these applications, the gas pressure may cause the panes of the insulating glass unit to bow outward, distorting the optics and/or appearance of the unit. Further, higher pressure gas inside the insulating glass unit may create stress on the peripheral seal of the insulating glass unit, reducing the service life of the seal. This may occur when the insulating glass unit is transported to the higher elevation location and there is less ambient pressure acting on the external surfaces of the panes to counteract the pressure of the gas inside the unit.

In general, this disclosure relates to systems and techniques for fabricating insulating glass units, such as insulating glass units that can be manufactured at one elevation and one ambient pressure and then transported to a higher elevation and a lower ambient pressure. In some examples, a between-pane space of an insulating glass unit is filled with a mixture of gases and a spacer containing a gas adsorption material is positioned in the between-pane space to seal the mixture of gases in the space. The mixture of gases and the gas adsorption material may be selected so that one of the gases in the mixture adsorbs on the gas adsorption material while another of the gases in the mixture does not adsorb on the gas adsorption material. For example, the mixture of gases may contain a polar molecule that adsorbs on the gas adsorption material and a non-polar molecule that does not adsorb on the gas adsorption material or adsorbs to only a minor extent.

After constructing the insulating glass unit in such an example, the gas that adsorbs on the gas adsorption material may so adsorb on the material, causing the composition of the gas in the insulating gas unit to change. The gas pressure inside the insulating glass unit may therefore reduce as gaseous atoms/molecules adsorb on the gas adsorption material. Depending on the application, the insulating glass unit may be filled to contain a gas mixture present at atmospheric pressure (e.g., atmospheric pressure at the location of manufacture). After sealing the gas mixture inside the insulating glass unit, a portion of the gas mixture may adsorb on the gas adsorption material, creating a partial negative pressure in the insulating glass unit (e.g., a partial negative pressure relative to atmospheric pressure at the location of manufacture). The composition of the gas introduced into the insulating glass unit and/or the gas adsorption material may be controlled so that the reduced pressure generated in the insulating glass unit after adsorption is complete is equal to or substantially equal to atmospheric pressure at a location of intended use that is at a higher elevation than the location of manufacture. That is, the insulating glass unit may be configured so that upon transporting the unit to a location where the atmospheric pressure is lower than the atmospheric pressure at the location of manufacture, the pressure inside the unit is equal to or substantially equal to the pressure at that end use location.

During manufacture of the insulating glass unit, the gas mixture is sealed inside the unit by positioning a spacer between opposed panes of transparent material. In one example, the gas mixture is injected between opposed panes of transparent material and then sealed by pressing the spacer between the opposed panes. In another example, the spacer is already partially present between the opposed panes of transparent material and the gas is injected through a hole in the spacer. When gas filling is completed in such an example, positioning of the spacer between the opposed panes of transparent material may be accomplished by filling the gas filling hole extending through the spacer, thereby sealing the between-pane space.

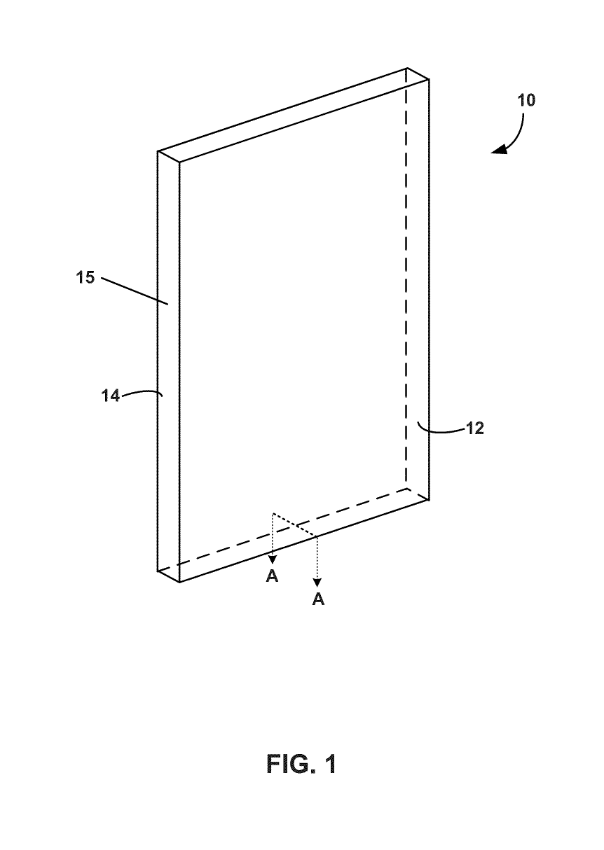

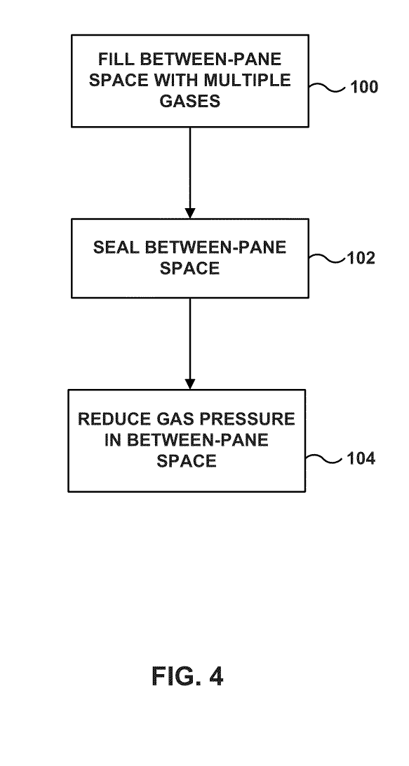

An example method of fabricating an insulating glass unit will be described in greater detail with respect to FIG. 4. However, an example insulating glass unit that may include a plurality of gases and a gas adsorption material will first be described with respect to FIGS. 1-3.

FIG. 1 is a perspective drawing of an example insulating glass unit 10 that is filled with a gas and that may contain a gas adsorption material. Insulating glass unit 10 defines a front surface 12 and a back surface 14. As described in greater detail below, insulating glass unit 10 includes at least two substrates separated by a spacer to define at least one between-pane space. The at least two substrates may be held apart from one another by a spacer that extends about a common perimeter 15 of the substrates and that hermetically seals the between-pane space created between the two substrates. Although insulating glass unit 10 in FIG. 1 is illustrated as being rectangular in shape, the unit can define any polygonal (e.g., square, hexagon, triangle) or arcuate (e.g., circular, elliptical) shape, or even combinations of polygonal and arcuate shapes.

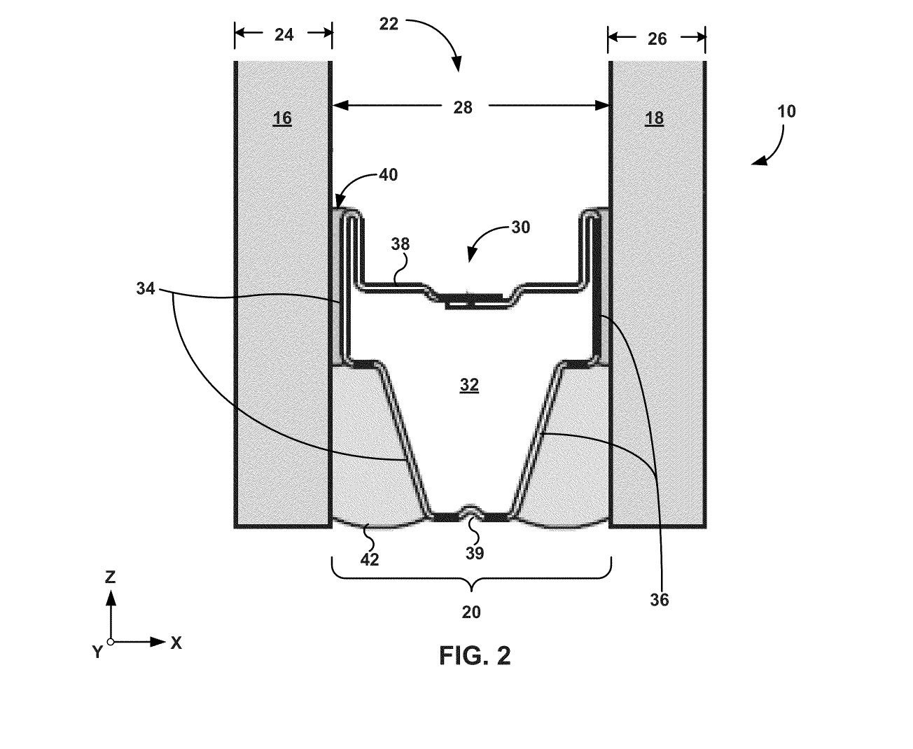

FIG. 2 is a cross-sectional view of an edge of insulating glass unit 10 taken along the A-A cross-sectional line indicated on FIG. 1. In this example, insulating glass unit 10 includes a first pane of transparent material 16 and a second pane of transparent material 18. The first pane of transparent material 16 is spaced apart from the second pane of transparent material 18 by a spacer 20 to define a between-pane space 22. Spacer 20 may extend around the entire perimeter 15 (FIG. 1) of insulating glass unit 10 to hermetically seal the between-pane space 22 from gas exchange with a surrounding environment. In some examples as described in greater detail below, spacer 20 contains a gas adsorption material and between-pane space 22 is filled with a plurality of gases. The gas adsorption material and/or composition of the plurality of gases may be configured so that the gas adsorption material adsorbs at least some of the gas in the between-pane space. As gas adsorbs from between-pane space 22 onto the surface of the gas adsorption material, the pressure in the between-pane space may reduce below the gas pressure in the space at the time insulating glass unit 10 was initially manufactured. Gas remaining in between-pane space 22 that does not adsorb on the gas adsorption material may reduce thermal transfer across insulating glass unit 10, e.g., as compared to when the between-pane space is filled with ambient air.

Insulating glass unit 10 in the example of FIG. 2 has two panes of transparent material: first pane of transparent material 16 and second pane of transparent material 18. Each pane of transparent material may be formed from the same material, or first pane of transparent material 16 may be formed of a different material than the second pane of transparent material 18. In some examples, at least one (and optionally all) the panes of insulating glass unit 10 are formed of glass. In various examples, the glass may be aluminum borosilicate glass, soda-lime (e.g., soda-lime-silicate) glass, or another type of glass. In addition, the glass may be clear or the glass may be colored, depending on the application. Although the glass can be manufactured using different techniques, in some examples the glass is manufactured on a float bath line in which molten glass is deposited on a bath of molten tin to shape and solidify the glass. Such an example glass may be referred to as float glass.

In addition, in examples in which at least one (and optionally all) the panes of insulating glass unit 10 are constructed of glass, the glass may or may not be thermally-strengthened glass. Thermally-strengthened glass is generally stronger and more shatter resistant than glass that is not thermally-strengthened. Examples of thermally-strengthened glass include tempered glass and Heat Strengthened glass.

In yet other examples, at least one (and optionally all) the panes of insulating glass unit 10 are formed of plastic such as, e.g., a fluorocarbon plastic, polypropylene, polyethylene, or polyester. Depending on the application, the first pane and/or the second pane of insulating glass unit 10 may be constructed of materials that are not transparent such as translucent materials or even opaque materials, which may or may not block light transmission through the panes.

In still other examples, at least one (and optionally all) the panes of insulating glass unit 10 are formed from multiple different types of materials. For example, the panes may be formed of a laminated glass, which may include two panes of glass bonded together with polyvinyl butyral. When insulating glass unit 10 does not include panes of glass, the unit may be referred to as an insulating unit or insulating glazing unit instead of an insulating glass unit, although the phrase insulating glass unit is generally used in this disclosure to refer to multi-pane insulating structures regardless of the specific materials used to fabricate the panes of the structures. It should be appreciated that although insulating glass unit 10 is only illustrated as having two planes of transparent material, the unit may include three or more panes defining two or more between-pane spaces, and the disclosure is not limited in this respect.

The first pane of transparent material 16 and/or the second pane of transparent material 18 may or may not be coated with one or more functional coatings to modify the performance of the transparent panes. Example functional coatings include, but are not limited to, low emissivity coatings and photocatalytic coatings. In general, a low emissivity coating is a coating that is designed to allow near infrared and visible light to pass through a pane while substantially preventing medium infrared and far infrared radiation from passing through the panes. A low emissivity coating may include one or more layers of infrared-reflection film interposed between two or more layers of transparent dielectric film. The infrared-reflection film may include (or, in other examples, consist or consist essentially of) a conductive metal like silver, gold, or copper. A photocatalytic coating, by contrast, may be a coating that includes a photocatalyst, such as titanium dioxide. In use, the photocatalyst may exhibit photoactivity that can help self-clean the panes after installation.

In the example of FIG. 2, the first pane of transparent material 16 of insulating glass unit 10 defines a first pane thickness 24 (i.e., in the X-direction indicated on FIG. 2) and the second pane of transparent material 18 defines a second pane thickness 26. The panes of insulating glass unit 10 may define any suitable thicknesses, and the thicknesses of the panes may vary, e.g., depending strength characteristics desired of the panes and the intended application of insulating glass unit 10. In some examples, first pane thickness 24 and second pane thickness 26 are sufficiently thin such that, when a gas adsorption material in spacer 20 adsorbs gas from between-pane space 22 (e.g., creating a partial vacuum in the between-pane space), the first pane of transparent material 16 and second pane of transparent material 18 flex inwards toward each other. In various examples, at least one (and optionally both) of first pane thickness 24 and second pane thickness 26 are less than 2.5 millimeters (mm) such as, e.g., less than 2.3 mm, or less than 2.0 mm. In one example, first pane thickness 24 and second pane thickness 26 each range from approximately 0.5 mm to approximately 2.7 mm, such as from approximately 1.5 mm to approximately 2.4 mm. First pane thickness 24 may be the same as or different than second pane thickness 26.

In the example of FIG. 2, spacer 20 holds the first pane of transparent material 16 a separation distance 28 from the second pane of transparent material 18 to define between-pane space 22. Separation distance 28 may be the shortest distance between the surface of the first pane of transparent material 16 facing between-pane space 22 and an opposing surface of the second pane of transparent material 18 facing the between-pane space. The dimensions of separation distance 28 may dictate the volume of gas that may be held in insulating glass unit 10. As examples, separation distance 28 may range from approximately 6.5 millimeters (mm) to approximately 21 mm, although other separation distances may also be used.

Insulating glass unit 10 in the example of FIG. 2 includes spacer 20. Spacer 20 may be a structure that holds opposed panes of transparent material in a spaced apart relationship over the service life of insulating glass unit 10 and seals the space between the opposed panes of transparent material, e.g., so as to inhibit or eliminate gas exchange between the between-pane space and an environment surrounding insulating glass unit 10. Any suitable spacer can be used as spacer 20, and the disclosure is not necessarily limited to an insulating glass unit having a spacer of any particular design.

In the example of FIG. 2, spacer 20 is formed from tubular spacer 30 that is positioned between the first pane of transparent material 16 and the second pane of transparent material 18. Tubular spacer 30 defines a hollow lumen or tube which, in some examples, is filled with a gas adsorption material (designated for purposes of illustration as reference numeral 32 in FIG. 2). Tubular spacer 30 includes a first side surface 34, a second side surface 36, a top surface 38 connecting first side surface 34 to second side surface 36, and a bottom surface 39 also connecting first side surface 34 to second side surface 36. First side surface 34 of tubular spacer 30 is positioned adjacent the first pane of transparent material 16 while second side surface 36 of the tubular spacer is positioned adjacent the second pane of transparent material 18. Top surface 38 is exposed to the between-pane space 22. In some examples, top surface 38 of tubular spacer 30 includes openings that allow gas within between-pane space 22 to communicate into the lumen, including with gas adsorption material 32 positioned within the lumen. When tubular spacer 30 is filled with gas adsorption material 32, gas communication between between-pane space 22 and the lumen can allow one or more gases present inside between-pane space 22 to communicate with gas adsorption material 32 in the spacer.

As mentioned above, between-pane space 22 of insulating glass unit 10 may be filled with a mixture of multiple gases during manufacture of the insulating glass unit. An insulating gas inside insulating glass unit 10 can reduce heat transfer across the unit as compared to if the unit does not contain insulating gas. To introduce the insulating gas into unit 10 during manufacture, the first pane of transparent material 16 and the second pane of transparent material 18 may be brought into a generally parallel and spaced apart relationship. Spacer 20 may be adhered to the perimeter of one of the panes of transparent material (e.g., first pane of transparent material 16) but not the other of the panes of transparent material. The gases can then be injected into the space between the first pane of transparent material 16 and second pane of transparent material 18 so as to displace any ambient gas (e.g., air) otherwise present between the two panes of transparent material. With the space between the two panes of transparent material filled with the introduced gas, the first pane of transparent material 16 and second pane of transparent material 18 can be pressed together, thereby sealing the gas mixture inside insulating glass unit 10.

In practice, insulating glass units are often filled with insulating gas so that the pressure of the gas sealed inside the unit is at the same pressure or substantially the same pressure as ambient gas outside of the unit. That is, the insulating glass unit may be filled so that the gas pressure inside the unit is not at a highly positive pressure or a highly negative pressure relative to air pressure outside of the unit but rather is substantially equal to air pressure surrounding the exterior of the unit. When the gas pressure inside the insulating glass unit is substantially equal to the air pressure outside of the unit, the forces acting on opposite sides of the transparent panes of the insulating glass unit may generally be in balance so there is little to no net pressure force acting to push the panes of the insulating glass unit inwards or outwards. By constructing the insulating glass unit so that the pressure of the gas inside the unit is substantially equal to the air pressure outside of the unit, the unit may experience less stress on spacer 20 than if there is a pressure imbalance.

In some applications, insulating glass unit 10 may be manufactured so that the pressure of the insulating gas inside the unit is substantially equal to (or, in other examples, equal to) the air pressure outside of the unit at the location of manufacture. If the insulating glass unit is desired to be used at a location where the ambient pressure outside of the insulating glass unit is less than the ambient pressure at the location of manufacture, a pressure imbalance may arise between the gas pressure inside the unit and ambient pressure outside of the unit, unless the gas pressure inside the unit is reduced below the initial pressure at the time of manufacture. Such a situation may occur, for example, if insulating glass unit 10 is manufactured at one elevation with respect to sea level and then transported to a mountainous area where the insulating glass unit installed at a higher elevation with respect to sea level (e.g., an area at an elevation more than 3000 feet above the elevation where the unit was manufactured, such as an elevation more than 5000 feet above the elevation where the unit was manufactured). The ambient pressure at the higher elevation location will be expected to have a lower ambient pressure than the ambient pressure at the lower elevation location.

To accommodate pressure changes that may occur between the location of manufacture and location of use for insulating glass unit 10, the insulating glass unit may be fabricated so that the gas pressure inside the unit reduces after manufacture. For example, insulating glass unit 10 may be fabricated so that between-pane space 22 of the insulating glass unit is filled with a mixture of gases and a gas adsorption material is positioned in gas communication with the mixture of gases. The mixture of gases and the gas adsorption material may be selected so that one or more of the gases in the mixture adsorbs on the gas adsorption material while one or more other of the gases in the mixture does not substantially adsorb on the gas adsorption material. Upon initially fabricating insulating glass unit 10 in such an example, between-pane space 22 may be filled with the mixture of gases and the mixture of gases may be at a certain pressure, such as ambient pressure. Overtime, one or more of the gases in the mixture of gases can adsorb on the gas adsorption material. When this occurs, the gas atoms and/or molecules that adsorb on the gas adsorption material may form a film on the surface of the gas adsorption material, thereby coming out of the mixture of gases in between-pane space 22.

As a result of the adsorption process, the gas pressure in between-pane space 22 may reduce below the initial gas pressure inside insulating glass unit 10 at the time the unit is fabricated. For example, if insulating glass unit 10 is initially filled so that the gas pressure in the unit is substantially the same as ambient pressure at the location of manufacture, the gas pressure in the unit may reduce to create a partial vacuum (e.g., partial negative pressure) relative to ambient pressure at that location of manufacture. In some examples, the amount of gas that is adsorbed from between-pane space 22 is controlled, for example by controlling the amount of gas adsorption material and/or the amount of adsorbable gas introduced into the unit. For example, the amount of gas that is adsorbed from between-pane space 22 may be controlled so that the gas pressure inside the unit after substantially all of the gas that will adsorb on the gas adsorption material has adsorbed is the same (or substantially the same) as the ambient pressure outside of the unit at a location of intended use, where the ambient pressure at the location of intended use is less than the ambient pressure at the location of manufacture.

The composition of the gas introduced into between-pane space 22 during manufacture of insulating glass unit 10 may vary, e.g., depending on the desired gas pressure inside the unit after adsorption and the thermal insulating properties of the unit. In general, insulating glass unit 10 is filled during manufacture with at least one gas that adsorbs on a gas adsorption material carried by the unit and at least one gas that does not adsorb on the gas adsorption material. After manufacture, the gas that adsorbs on the gas adsorption material may so adsorb on the material whereas the gas that does not adsorb on the material may remain in a gaseous state, filling between-pane space 22.

In one example, insulating glass unit 10 is filled with a mixture of gases during manufacture that includes gases having different molecular/atomic sizes. Insulating glass unit 10 in this example may carry a gas adsorption material having pores that allows gas with a molecular or atomic size less than the pore size into the gas adsorption material—and thereby allowing the gas to adsorb on the material—while substantially excluding gas with a molecular or atomic size greater than the pore size of the gas adsorption material. As examples, insulating glass unit 10 may carry a gas adsorption material 32 having an average pore size (e.g., mean pore size, median pore size) ranging from 1 angstrom (Å) to 10 Å, such as from 2 Å to 6 Å, or from 3 Å to 4 Å. For instance, in different examples, insulating glass unit 10 may carry a gas adsorption material having an average pore size of approximately 3 Å or approximately 4 Å.

When insulating glass unit 10 includes a gas adsorption material having a certain pore size, the unit may be filled with at least one gas having a molecular or atomic size small enough to enter the material and adsorb on the material (e.g., a molecular or atomic size smaller than the pore size) and at least one gas having a molecular or atomic size large enough to be excluded from the material so as to not substantially adsorb on the material (e.g., a molecular or atomic size larger than the pore size). Typical insulating gases used in the manufacture of insulting glass units include, but are not limited to, argon, krypton, and xenon. Argon has a reported diameter of 3.8 Å, while krypton and argon have diameters larger than argon. Smaller diameter gases include, but are not limited to, helium (reported diameter of 2.0 Å), hydrogen (reported diameter of 2.4 Å), acetylene (reported diameter of 2.4 Å), oxygen (reported diameter of 2.8 Å), carbon dioxide (reported diameter of 2.8 Å), and nitrogen (reported diameter of 3.0 Å).

In some examples, insulating glass unit 10 includes a gas adsorption material having a pore size small enough to substantially (or, in other examples, entirely) exclude atoms or molecules the size of argon or larger from adsorbing on the gas adsorption material. In such examples, insulating glass unit 10 may be filled with an insulating gas the size of argon or larger (e.g., argon, krypton, xenon) and a gas smaller than the size of argon (e.g., hydrogen, helium, carbon dioxide, oxygen, carbon monoxide). After manufacturing insulating glass unit according to such an example, the smaller size gas atoms or molecules may adsorb on the gas adsorption material while the larger size gas atoms or molecules may remain substantially unadsorbed, filling between-pane space 22.

Given the fact that ambient air usually contains about 78 volume percent nitrogen, the gas adsorption material carried by insulating glass unit 10 may be selected to have an average pore size small enough to exclude nitrogen from entering and adsorbing on the material. Otherwise, nitrogen present in the ambient air during manufacture of insulating glass unit 10 may adsorb on the gas adsorption material, preventing the gas adsorption material from subsequently adsorbing other gas from between-pane space 22. Nitrogen has a reported diameter of 3.0 Å. Thus, using a gas adsorption material having an average pore size less than or equal to 3.0 Å may be sufficient to exclude nitrogen from substantially adsorbing on the material. In such an example, insulating glass unit 10 may be filled with a gas mixture that includes a gas having an atomic or molecular size (e.g., diameter) greater than or equal to 3.0 Å and another gas having an atomic or molecular size less than 3.0 Å. In other examples, however, a gas adsorption material carried by insulating glass unit 10 may adsorb nitrogen from the air, and it should be appreciated that an insulating glass unit in accordance with the disclosure is not limited to having a gas adsorption material that does not adsorb nitrogen.

In one example, insulating glass unit 10 is filled with multiple gases that include a first gas composition having an atomic or molecular size (e.g., diameter) less than 3.5 Å and a second gas composition that includes one of argon, krypton, and xenon. For example, insulating glass unit 10 may be filled during manufacture to include one (or more) of hydrogen, helium, oxygen, and carbon dioxide and one (or more) of argon, krypton, and xenon. As a specific example, insulating glass unit 10 may be filled with argon and carbon dioxide. As another specific example, insulating glass unit 10 may be filled with krypton and carbon dioxide. The gas adsorption material carried by insulating glass unit 10 may be configured to adsorb the smaller sized gas atom or molecule while adsorbing substantially none of the larger sized gas atom or molecule.

In addition to or in lieu of filling between-pane space 22 with a mixture of gases having different molecular or atomic sizes during the manufacture of insulating glass unit 10, the insulating glass unit may be filled with a mixture of gases having different polarities. In general, polarity refers to a separation of electric charge (e.g., an uneven distribution of electrons) leading a molecule to have an electric dipole moment. A non-polar molecule may have a balanced electrical charge so that there is electrical symmetry about the molecule. In some examples, insulating glass unit 10 is filled with a mixture of gases that includes at least one gas that is a polar molecule and at least one gas that is a non-polar molecule. In such an example, the gas adsorption material carried by the insulating glass unit may be configured to adsorb the polar molecule but adsorb substantially none of the non-polar molecule.

Independent of the specific types of gases selected to be dispensed into between-pane space 22 during the fabrication of insulating glass unit 10, the unit may be filled with any suitable amount of each selected gas. In some examples, the amount of each gas will be controlled to control the pressure inside insulating glass unit 10 after substantially any (or, in other examples, any) gas that will adsorb on a gas adsorption material carried by the unit does in fact so adsorb. In other words, the amount of each gas introduced into insulating glass unit 10 may be controlled so that the pressure inside the unit after adsorption will be at a certain pressure or within a certain range of pressures. In general, increasing the amount of gas introduced into insulating glass unit 10 that will adsorb on the gas adsorption material and/or reducing the amount of gas introduced into the unit that does not adsorb on the material will reduce the gas pressure in the unit after adsorption.

In some examples, insulating glass unit 10 is filled with gas so that the pressure inside the unit at the time of manufacture (e.g., at a time less than 5 minutes after sealing the gas mixture inside the unit) is greater than or equal to 0.5 atmospheres of pressure absolute. For example, insulating glass unit 10 may be filled with gas so that the pressure inside the unit at the time of manufacture ranges from 0.5 atmospheres of pressure absolute to 5 atmospheres of pressure absolute such as, e.g., from 0.65 atmospheres of pressure absolute to 3 atmospheres of pressure absolute, or from 0.85 atmospheres of pressure absolute to 1.5 atmospheres of pressure absolute. For example, insulating glass unit 10 may be may be filled with gas so that the pressure inside the unit at the time of manufacture is approximately 1 atmosphere of pressure absolute (101.3 KPa absolute).

The composition of the gas introduced into insulating glass unit 10 during manufacture may be controlled such that the pressure reduction caused by adsorption of one or more of the gases on the gas adsorption material is greater than 0.01 atmospheres of pressure, such as greater than 0.05 atmospheres of pressure, or greater than 0.1 atmospheres of pressure. For example, the composition of the gas introduced into insulating glass unit 10 may be controlled so that the pressure reduction caused by adsorption of one or more of the gases ranges from approximately 0.025 atmospheres of pressure to approximately 0.25 atmospheres of pressure, such as from approximately 0.05 atmospheres of pressure to approximately 0.15 atmospheres of pressure. The amount of gas pressure reduction in insulating glass unit 10 may be determined by comparing the gas pressure in the unit at the time of manufacture to the gas pressure in the unit after manufacture (e.g., at least 3 days after manufacture, at least 5 days after manufacture, at least 10 days after manufacture).

The gas pressure inside insulating glass unit 10 after any gas that will adsorb on the gas adsorption material carried by the unit has so adsorbed will vary, e.g., depending on the composition of the gas, the configuration of the gas adsorption material, and the initial gas pressure inside the unit at the time of manufacture. That being said, in various examples, the pressure inside the unit after any gas that will adsorb on the gas adsorption material carried by the unit has so adsorbed may be less than 1.0 atmosphere of pressure absolute, such as less than 0.9 atmospheres of pressure absolute, or less than 0.85 atmospheres of pressure absolute. For example, the pressure may range from approximately 0.5 atmospheres of pressure absolute to approximately 1.0 atmosphere of pressure absolute, such as from approximately 0.7 atmospheres of pressure absolute to approximately 0.9 atmospheres of pressure absolute, or from approximately 0.75 atmospheres of pressure absolute to approximately 0.85 atmospheres of pressure absolute. In practice, it may be expected that any gas inside insulating glass unit 10 that will adsorb on the gas adsorption material carried by the unit will so adsorb following a certain period of time after manufacture (e.g., at least 3 days after manufacture, at least 5 days after manufacture, at least 10 days after manufacture).

As noted above, the pressure inside insulating glass unit 10 can be controlled by controlling the amount of the different gases introduced into the unit during manufacture. In general, insulating glass unit 10 is filled during manufacture with at least one gas that adsorbs on a gas adsorption material carried by the unit and at least one gas that does not substantially adsorb on the gas adsorption material. In some applications in accordance with these examples, insulating glass unit 10 is filled during manufacture so that the amount of gas that adsorbs on the gas adsorption material ranges from approximately 2 volume percent to approximately 40 volume percent of the total volume of gas introduced into the unit during manufacture such as, e.g., from approximately 5 volume percent to approximately 30 volume percent, or from approximately 10 volume percent to approximately 20 volume percent of the total volume of gas. The volume of gas introduced into insulating glass unit 10 in these examples that does not substantially adsorb on the gas adsorption material may range from approximately 98 volume percent to approximately 60 volume percent of the total volume of gas introduced into the unit during manufacture, such as, e.g., from approximately 95 volume percent to approximately 70 volume percent, or from approximately 90 volume percent to approximately 80 volume percent of the total volume of gas. A gas may not substantially adsorb on the gas adsorption material carried by insulating glass unit 10 in that less than 5 volume percent of the gas introduced into insulating glass unit 10 during manufacture may subsequently adsorb on the gas adsorption material carried by the unit, such as less than 1 volume percent, less than 0.5 volume percent, or less than 0.1 volume percent of the gas.

Regardless of the absolute pressure inside insulating glass unit 10 at the time of manufacture and the composition of the gas introduced into the unit, the unit may or may not be filled so that the pressure inside the unit is approximately the same (e.g., plus or minus five percent, plus or minus one percent) as the ambient pressure outside of the unit at the location of manufacture. Depending on the application, the composition of the gas introduced into insulating glass unit 10 at the time of manufacture may be controlled such that the pressure inside the unit after adsorption is approximately the same as the ambient pressure that will be present outside of the unit at a higher elevation location to which the insulating glass unit is intended to be shipped and installed.

As one example, assume that insulating glass unit 10 was to be manufactured at sea level and then transported to an elevation approximately 5500 feet above sea level for installation. Ambient pressure at sea level at standard conditions is typically reported to be approximately 1 atmosphere of pressure absolute whereas ambient pressure at an elevation of 5500 feet above sea level at standard conditions is usually reported to be approximately 0.85 atmospheres of pressure absolute. To construct insulating glass unit 10 so that the gas pressure inside the unit after adsorption is approximately 0.85 atmospheres of pressure absolute, the unit may be filled to approximately 1 atmosphere of pressure absolute with a gas mixture that includes approximately 15 volume percent of a gas composition that adsorbs on the gas adsorption material carried by the unit (e.g., one or more of hydrogen, helium, oxygen, carbon dioxide) and approximately 85 volume percent of a gas composition that does not substantially adsorb on the gas adsorption material (e.g., one or more of argon, krypton, xenon). Assuming that insulating glass unit 10 carries a sufficient amount of gas adsorption material so that substantially all (or, in other examples, all) of the gas that can adsorb on the material does in fact adsorb on the material, the resulting pressure in the unit after adsorption may be approximately 0.85 atmospheres of pressure absolute. After adsorption, the composition of the gas inside insulating glass unit 10 may be substantially free (e.g., contain less than one percent, less than 0.5 volume percent) of the gas introduced into the unit that is configured to adsorb on the gas adsorption material. In other words, between-pane space 22 of insulating glass unit 10 may be filled with the gas that does not substantially adsorb on the gas adsorption material (e.g., so that argon, krypton, and/or xenon may form of approximately 100 percent of total volume of gas in the space) after adsorption.

With further reference to FIG. 2, spacer 20 is illustrated as including tubular spacer 30 filled with gas adsorption material 32. Gas adsorption material 32 may be a solid-phase material that is held by spacer 20 and in gas communication with gas within between-pane space 22. After fabricating insulating glass unit 10, gas within between-pane space 22 may move past the surface of gas adsorption material 32 and, depending on the type of gas, adsorb on the material. A gas may adsorb on gas adsorption material 32 by having atoms/molecules of the gas accumulate on the surface of gas adsorption material, forming a thin film on the surface of the material.

As mentioned above, insulating glass unit 10 may be filled during manufacture with at least one gas that adsorbs on gas adsorption material 32 and at least one gas that does not substantially adsorb on the material. In some examples, gas adsorption material 32 is configured to adsorb multiple gases that may be present in insulating glass unit 10 while not substantially adsorbing at least one other gas present in the unit. For example, gas adsorption material 32 may be configured to adsorb a relatively small size gas atom or molecule (e.g., hydrogen, helium, oxygen, carbon dioxide) while not substantially adsorbing a comparatively larger size gas atom or molecule (e.g., argon, krypton, xenon). In these examples, gas adsorption material 32 may further adsorb other relatively small size gas atoms or molecules that may be present in the insulting glass unit, such as water (e.g., water vapor) that may be present in the unit. When so configured, gas adsorption material 32 may adsorb both gas from between-pane space 22 for purposes of reducing the gas pressure inside insulating glass unit 10 and also adsorb any moisture that may be present inside the unit, e.g., to help prevent moisture fogging inside the unit.

In general, gas adsorption material 32 may be any material that is configured to adsorb one more gases from between-pane space 22 of insulating glass unit 10. In one example, gas adsorption material 32 is a desiccant. The desiccant may be a loose-filled desiccant (e.g., a powder, a bead, a pellet), a desiccant matrix (e.g., desiccant embedded in a polymeric material), or another suitable type of desiccant. In addition, the gas adsorption material 32 may define a single pore size (e.g., three angstroms) or a combination of differ pore sizes (e.g., a blend of different pore sizes). In various examples, gas adsorption material 32 may be or include a silica gel, a molecular sieve, and/or activated alumina.

In the example of FIG. 2, spacer 20 includes tubular spacer 30 and at least one sealant positioned between tubular spacer 30 and opposing panes of insulating glass unit 10. In particular, in the example of FIG. 2, spacer 20 is illustrated as including a primary sealant 40 and a secondary sealant 42. Primary sealant 40 is positioned between a portion of first side surface 34 extending substantially parallel to the first pane of transparent material 16 and a portion of second side surface 36 extending substantially parallel to the second pane of transparent material 18. Secondary sealant 42 is positioned between a portion of first side surface 34 diverging away from the first pane of transparent material 16 and a portion of second side surface 36 diverging away from the second pane of transparent material 18.

Tubular spacer 30 may be a rigid structure that holds the first pane of transparent material 16 apart from the second pane of transparent material 18 over the service life of insulating glass unit 10. Tubular spacer 30 may be rigid in that the structure does not compress when compressive force push first pane of transparent material 16 toward second pane of transparent material 18. In different examples, tubular spacer 30 is fabricated from aluminum, stainless steel, a thermoplastic, or any other suitable material. In addition, while tubular spacer 30 is generally illustrated as defining a W-shaped cross-section (i.e., in the X-Z plane indicated on FIG. 2), tubular spacer 30 can define any polygonal (e.g., square, hexagonal) or arcuate (e.g., circular, elliptical) shape, or even combinations of polygonal and arcuate shapes.

Primary sealant 40 may contact and adhere first side surface 34 of tubular spacer 30 to the first pane of transparent material 16 and may also contact and adhere second side surface 36 of tubular spacer 30 to the second pane of transparent material 18. Because spacer 20 is generally configured to hermetically seal between-pane space 22, primary sealant may be selected to prevent moisture and/or ambient gas from entering between-pane space 22 and also to prevent gas from escaping from the between-pane space. Secondary sealant 42 may help seal the between-pane space 22 from gas communication with an environment surrounding insulating glass unit 10. Secondary sealant 42 may also help maintain a substantially constant separation distance 28 between the first pane of transparent material 16 and the second pane of transparent material 18 over the service life of insulating glass unit 10. For example, secondary sealant 42 may be selected as a material that resists compression over the service life of insulating glass unit 10.

Example materials that may be used as primary sealant 40 include, but are not limited to, extrudable thermoplastic materials, butyl rubber sealants (e.g., polyisobutylene-based thermoplastics), polysulfide sealants, and polyurethane sealants. In some examples, primary sealant 40 is formed from a butyl rubber sealant that includes silicone functional groups or a polyurethane sealant that includes silicone functional groups. Example materials that may be used as secondary sealant 42 include acrylate polymers, silicone-based polymers, extrudable thermoplastic materials, butyl rubber sealants (e.g., polyisobutylene-based thermoplastics), polysulfide sealants, polyurethane sealants, and silicone-based sealants. For example, secondary sealant 42 may be formed from a butyl rubber sealant that includes silicone functional groups or a polyurethane sealant that includes silicone functional groups. The composition of primary sealant 40 may be the same as or different than the composition of secondary sealant 42.

Although gas adsorption material 32 is illustrated in FIG. 2 as being positioned within tubular spacer 30, the gas adsorption material may be embedded within primary sealant 40 and/or secondary sealant 42 in addition to or in lieu of being within tubular spacer 30. Further, although spacer 20 in the illustrated example includes primary sealant 40 and secondary sealant 42, in other examples, spacer 20 may include fewer sealants (e.g., a single sealant) or more sealants (e.g., three, four, or more). In addition, other arrangements of primary sealant 40 and secondary sealant 42 relative to tubular spacer 30 are both possible and contemplated. For instance, in some examples, spacer 20 includes additional secondary sealant 42 covering bottom surface 39 of tubular spacer 30 (e.g., so as to contact bottom surface 39 while extending continuously between the first pane of transparent material 16 and the second pane of transparent material 18). In other examples, such as the example illustrated in FIG. 2, secondary sealant 42 is not positioned adjacent bottom surface 39 of tubular spacer 30.

The design of spacer 20 illustrated with respect to FIG. 2 is merely one example. In other examples, spacer 20 may be formed from a corrugated metal reinforcing sheet surrounded by a primary sealant composition. The corrugated metal reinforcing sheet may be a rigid structural component that holds the first pane of transparent material 16 apart from the second pane of transparent material 18. In some examples, a secondary sealant composition also applied in contact with an outer surface of the primary sealant composition. Gas adsorption material 32 may be embedded within the primary sealant composition and/or secondary sealant composition in such an example. A spacer with a corrugated metal reinforcing sheet is often referred to in commercial settings as swiggle spacer.

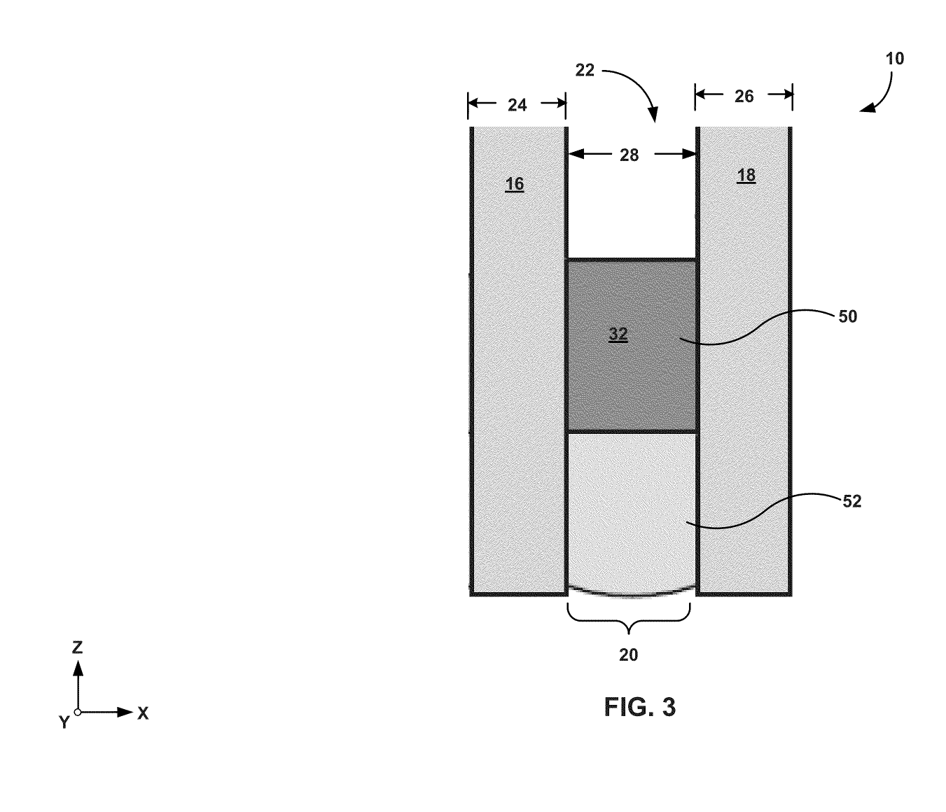

FIG. 3 is a cross-sectional view of another example configuration of insulating glass unit 10, where the view is taken along the A-A cross-sectional line indicated on FIG. 1. The example configuration of insulating glass unit 10 in FIG. 3 is the same as in FIG. 2 except that spacer 20 has a different configuration than the configuration in FIG. 2. In the example of FIG. 3, spacer 20 is illustrated as being thermoplastic spacer (TPS) spacer that includes a primary sealant layer 50 and a secondary sealant layer 52. Primary sealant layer 50 extends from a surface of the first pane of transparent material 16 facing between-pane space 22 to an opposing surface of the second pane of transparent material 18 facing the between-pane space. As with spacer 20 in FIG. 2, primary sealant layer 50 in spacer 20 of FIG. 3 may be selected to prevent moisture from entering between-pane space 22 and also to prevent gas from escaping from the between-pane space. Secondary sealant layer 52 may help seal the between-pane space 22 from gas communication with an environment surrounding insulating glass unit 10. Secondary sealant layer 52 may also help maintain a substantially constant separation distance 28 between the first pane of transparent material 16 and the second pane of transparent material 18 over the service life of insulating glass unit 10. For example, secondary sealant layer 52 may be selected as a material that resists compression over the service life of insulating glass unit 10.

Example materials that may be used as primary sealant layer 50 and secondary sealant layer 52 include those materials described above with respect to primary sealant 40 and secondary sealant 42 in FIG. 2. For instance, example materials that may be used as primary sealant layer 50 include butyl rubbers (e.g., polyisobutylene), polysulfides, polyurethanes, and the like such as butyl rubbers with silicone functional groups or polyurethanes with silicone functional groups. Example materials that may be used as secondary sealant layer 52 include acrylate polymers, silicone-based polymers, acrylate polymers, butyl rubbers (e.g., polyisobutylene), polysulfides, polyurethanes, silicones and combinations thereof such as butyl rubbers with silicone functional groups or polyurethanes with silicone functional groups. In some examples, the composition of primary sealant layer 50 is the same as the composition of secondary sealant layer 52. In other examples, the composition of primary sealant layer 50 is different than the composition of secondary sealant layer 52.

Spacer 20 in FIG. 3 may include gas adsorption material 32 embedded within primary sealant layer 50 and/or secondary sealant layer 52. The gas adsorption material may include any of the materials described herein as being suitable for insulating glass unit 10. In some examples, the gas adsorption material is configured to both adsorb gas from between-pane space 22 for purposes of reducing the gas pressure inside insulating glass unit 10 and to also adsorb any moisture that may be present inside the unit.

To fabricate spacer 20 in FIG. 3, a primary sealant composition may be positioned between the first pane of transparent material 16 and the second pane of transparent material 18. A secondary sealant may then be applied around the perimeter defined between the first pane of transparent material 16 and the second pane of transparent material 18, in contact with the primary sealant. Gas adsorption material 32 can be intermixed with the primary sealant composition and/or the secondary sealant composition prior to application.

Different insulating glass unit configurations have been described in relation to FIGS. 1-3. FIG. 4 is a flow chart illustrating an example method of fabricating an insulating glass unit. For ease of description, the method of FIG. 4 is described with respect to the fabrication of insulating glass unit 10 in FIGS. 1 and 2. In other examples, however, the method of FIG. 4 may be used to form insulating glass units having other configurations, as described herein.

As shown in the example method of FIG. 4, the fabrication of insulating glass unit 10 include filling between-pane space 22 of insulating glass unit 10 with multiple gases (100). To fill between-pane space 22 with the gases (100), first pane of transparent material 16 may be brought into generally parallel alignment with second pane of transparent material 18, e.g., so that the panes of transparent material are separated from each other by a distance greater than separation distance 28 in the resulting insulating glass unit. With first pane of transparent material 16 and second pane of transparent material 18 in a generally parallel and spaced apart relationship, the multiple gases may be introduced into the space between the panes. In some examples, the multiple gases are introduced at the bottom of the space between the panes and allowed to flow upwards with respect to gravity. Regardless, as the space between the panes fills with the gases, the gases may displace any and/or all ambient air that may otherwise be present between the panes.

The specific gases introduced between the first pane of transparent material 16 and the second pane of transparent material 18 may vary, e.g., depending on the desired thermal insulating properties of the resulting insulating glass unit and the desired gas pressure in the unit after fabrication. In some examples, the space between the panes of transparent material is filled with at least one gas that will adsorb on a gas adsorption material to be carried by the insulating glass unit and at least one gas that does not substantially adsorb on the gas adsorption material. For example, where the gas adsorption material is configured to adsorb gas atoms and/or molecules of a certain size but not substantially adsorb gas atoms and/or molecules of a larger size, the space between the panes of transparent material may be filled with a gas composition having a comparatively small sized gas atom and/or molecule and another gas composition having a comparatively large sized gas atom and/or molecule. In some examples, the space between the panes of transparent material are filled with a gas composition having a diameter less than 3 angstroms, such as hydrogen helium, oxygen, carbon monoxide, and/or carbon dioxide and another gas composition having diameter greater than 3 angstroms, such as argon, krypton, and/or xenon. The gases may be mixed prior to filling the space between the panes of transparent material or may be introduced separately between the panes of material (e.g., either at the same time or at different times in series).

The space between the first pane of transparent material 16 and the second pane of transparent material 18 may be filled with the gases so that the resulting gas pressure in the insulating glass unit immediately after manufacture is at any suitable pressure. In some examples, the space between the panes of transparent material is filled with the gases so that the gas pressure in between-pane space 22 immediately after fabrication is substantially equal to ambient air pressure at the location where insulating glass unit 10 is being manufactured. For example, if insulating glass unit 10 is being manufactured at sea level where ambient air pressure is one atmosphere of pressure absolute, the gases may be introduced into the space between the panes of transparent material so the gas pressure in the unit is approximately one atmosphere of pressure absolute.

The example method of FIG. 4 also includes sealing between-pane space 22 so as to prevent the gases introduced into the space from communicating with ambient air surrounding insulating glass unit 10 (102). Between-pane space 22 may be sealed by positioning spacer 20 between the first pane of transparent material 16 and the second pane of transparent material 18. In some examples, primary sealant 40 is dispensed on tubular spacer 30 and the tubular spacer is adhered to a surface of the first pane of transparent material 16 but not an opposing surface of the second pane of transparent material 18. Instead, the panes of transparent material may be brought together in a generally parallel and spaced apart orientation so that there is a space between tubular spacer 30 adhered to the first pane of transparent material 16 and the second pane of transparent material 18. The gases introduced into between-pane space 22 may be introduced through the space between tubular spacer 30 adhered to the first pane of transparent material 16 and the second pane of transparent material 18.

With between-pane space 22 suitably filled with the multiple gases (100), the first pane of transparent material 16 and the second pane of transparent material 18 can be pressed together so as to adhere tubular spacer 30 to both panes of transparent material via primary sealant 40. Subsequently, secondary sealant 42 can be dispensed around the perimeter of insulating glass unit 10 to complete the fabrication of spacer 20 and to seal between-pane space 22.

In yet other examples, the first pane of transparent material 16 and the second pane of transparent material 18 may be brought into generally parallel and spaced apart relationship and adhered together by positioning spacer 20 between the panes. With the first pane of transparent material 16 and the second pane of transparent material 18 adhered together to define between-pane space 22, a gas filling lance can be inserted through an aperture in the spacer. Thereafter, between-pane space 22 can by filled with multiple gases by injecting the gases through the lance (100). When between-pane space 22 is suitably filled with the gases, the lance can be withdrawn from the insulating glass unit and aperture in the spacer sealed, thereby preventing the gases introduced into the space from communicating with ambient air surrounding insulating glass unit 10 (102).

With fabrication of insulating glass unit 10 complete, the gas pressure inside insulating glass unit 10 may be reduced by adsorption of one or more of the gases inside the unit on gas adsorption material 32 (104). The amount the gas pressure is reduced in the unit may depend, e.g., on the configuration of the gas adsorption material and the amount of gas introduced into the unit that is configured to adsorb on the material. In some examples, insulating glass unit 10 is filled so that the unit includes from approximately 5 volume percent to approximately 30 volume percent (e.g., 15 volume percent) of a gas composition that adsorbs on the gas adsorption material and a remaining volume percentage from approximately 95 volume percent to approximately 70 volume percent (e.g., 85 volume percent) that does not substantially adsorb on the gas adsorption material. The gas composition that is selected to adsorb on gas adsorption material 32 may so adsorb on the material, changing the composition of the gas remaining in between-pane space 22. In some examples, substantially all of the gas composition that adsorbs on the gas adsorption material does so absorb, such that the gas remaining in between-pane space 22 is substantially entirely (e.g., approximately 100 volume percent) that of the gas composition that does not substantially adsorb on the gas adsorption material.

In some examples, the gas pressure reduction caused by adsorption of gas creates a negative pressure inside the unit (e.g., relative to ambient air surrounding insulating glass unit 10) that cause first pane of transparent material 16 and second pane of transparent material 18 to bow towards one another. For example, the panes may bow towards one another near the geometric center of the panes such that that separation distance 28 between the panes is less where the panes bow together than at the peripheral edges of the panes, where separation distance 28 is fixed by spacer 20. In such an example, the panes of transparent material may return to an unbowed orientation (e.g., where separation distance 28 is uniform across the length of insulating glass unit 10), when insulating glass unit 10 is transported to a location where ambient air pressure acting on the external surfaces of the panes is less than the ambient air pressure at the location of manufacture.

Various examples have been described. These and other examples are within the scope of the following claims.

1. A method comprising:
filling a between-pane space defined between a first pane of transparent material and a second pane of transparent material with a plurality of gases, wherein the plurality of gases include a first gas composition and a second gas composition;
positioning a spacer between the first pane of transparent material and a second pane of transparent material so as to seal the between-pane space from gas exchange with a surrounding environment, wherein the spacer comprises a gas adsorption material configured to adsorb the first gas composition; and
reducing a gas pressure in the between-pane space via adsorption of the first gas composition by the gas adsorption material so that the gas pressure in the between-pane space is reduced below atmospheric pressure.

2. The method of claim 1, wherein the first gas composition comprises greater than 10 volume percent of a total volume of the plurality of gases.

3. The method of claim 1, wherein the first gas composition ranges from approximately 5 volume percent to approximately 30 volume percent of a total volume of the plurality of gases, and the second gas composition ranges from approximately 95 volume percent to approximately 70 volume percent of the total volume of the plurality of gases.

4. The method of claim 3, wherein the first gas composition comprises one of hydrogen, helium, oxygen, and carbon dioxide, and the second gas composition comprises one of argon, krypton, and xenon.

5. The method of claim 4, wherein the first gas composition comprises carbon dioxide.

6. The method of claim 3, wherein the first gas composition comprises a polar molecule and the second gas composition comprises a non-polar molecule.

7. The method of claim 1, wherein reducing the gas pressure in the between-pane space comprises reducing the gas pressure below 0.9 atmospheres of pressure absolute.

8. The method of claim 1, wherein the gas adsorption material comprises a desiccant.

9. The method of claim 8, wherein the desiccant is configured to adsorb substantially all of the first gas composition and substantially none of the second gas composition.

10. The method of claim 1, wherein reducing the gas pressure comprises reducing the gas pressure an amount sufficient to cause the first pane of transparent material and the second pane of transparent material to bow towards one another.

11. A method comprising:
filling a between-pane space defined between a first glass pane and a second glass pane with a plurality of gases, wherein the plurality of gases include a first gas defining a first molecular or atomic size and a second gas defining a second molecular or atomic size larger than the first molecular or atomic size;
sealing the between-pane space from gas exchange with a surrounding environment with a spacer so as to form an insulating glass unit, wherein the spacer includes a gas adsorption material that has pores sized to allow passage of the first gas into the gas adsorption material and to substantially exclude passage of the second gas into the gas adsorption material; and
removing a portion of the first gas from the between-pane space via adsorption of the first gas by the gas adsorption material so as to reduce a pressure in the between-pane space.

12. The method of claim 11, wherein the first gas ranges from approximately 5 volume percent to approximately 30 volume percent of a total volume of the plurality of gases, and the second gas composition ranges from approximately 95 volume percent to approximately 70 volume percent of the total volume of the plurality of gases.

13. The method of claim 11, wherein the gas adsorption material comprises a desiccant having an average pore size of approximately 3 angstroms, the first molecular or atomic size is less than or equal to the average pore size, and the second molecular or atomic size is greater than the average pore size.

14. The method of claim 11, wherein the first gas comprises one of hydrogen, helium, and carbon dioxide, and the second gas comprises one of argon, krypton, and xenon.

15. The method of claim 11, wherein removing the portion of the first gas comprises removing substantially all of the first gas from the between-pane space.

16. The method of claim 11, wherein removing the portion of the first gas comprises removing a sufficient amount of gas so as to reduce the pressure in the between-pane space below 0.9 atmospheres of pressure absolute.

17. The method of claim 16, further comprising transporting the insulating glass unit to an elevation where the pressure in the between-pane space is substantially equal to atmospheric pressure at the elevation.

18. A method comprising:
positioning a first pane of transparent material so that the first pane of transparent material is generally parallel to and spaced apart from a second pane of transparent material;
filling a between-pane space defined between a first pane of transparent material and a second pane of transparent material with a plurality of gases;
positioning a spacer between the first pane of transparent material and a second pane of transparent material so as to seal the between-pane space from gas exchange with a surrounding environment and so as to form an insulating glazing unit; and
adsorbing one of the plurality of gases from the between-pane space via a desiccant positioned within the between-pane space while another of the plurality of gases is substantially unadsorbed by the desiccant so as to reduce a pressure in the between-pane space.

19. The method of claim 18, wherein adsorbing one of the plurality of gases so as to reduce the pressure in the between-pane space comprises adsorbing a sufficient amount of gas so as to create a partial vacuum in the between-pane space and to cause the first pane of transparent material and the second pane of transparent material to bow towards one another.

20. The method of claim 18, wherein the spacer comprises a tubular spacer filled with the desiccant.

21. The method of claim 18, wherein filling the between-pane space comprises filling the between-pane space so that the one of the plurality of gases adsorbed by the desiccant ranges from approximately 5 volume percent to approximately 30 volume percent of a total volume of the plurality of gases, and the one of the plurality of gases substantially unadsorbed by the desiccant ranges from approximately 95 volume percent to approximately 70 volume percent of the total volume of the plurality of gases.

22. The method of claim 18, wherein one of the plurality of gases adsorbed by the desiccant comprises one of hydrogen, helium, and carbon dioxide, and the one of the plurality of gases substantially unadsorbed by the desiccant comprises one of argon, krypton, and xenon, and wherein adsorbing one of the plurality of gases so as to reduce the pressure comprises reducing the pressure to a pressure ranging from 0.7 atmospheres of pressure absolute to 0.9 atmospheres of pressure absolute.
